(19) United States
(12) Patent Application Publication
(10) Pub. No.: US 2007/0225983 A1
(43) Pub. Date: Sep. 27, 2007

(54) Worldwide time device

(76) Inventors: Theodore Maringo, Matthews, NC (US); Daniel John Kroboth, Falls Church, VA (US)

Correspondence Address: TIMOTHY R. KROBOTH;KROBOTH LAW OFFICE, 5501 PROVIDENCE COUNTRY CLUB DRIVE, CHARLOTTE, NC, 28277, US

(21) Appl. No.: 11/386,729

(22) Filed: Mar. 23, 2006

(51) Int. Cl. G10L 21/00

(52) U.S. Cl. 704/270

(57) ABSTRACT

A speech recognition-based, digital electronic timekeeping device capable of displaying current time information for numerous worldwide locations, is described. Speech recognition templates are stored in the device memory, and include a speech recognition template for a spoken worldwide location, that includes a plurality of randomly accessible city entries. In one aspect of the invention, an algorithm for a worldwide current time function includes a hierarchical order of the speech recognition templates directed to the selection of a city spoken by the user. In another aspect of the invention, an algorithm for the worldwide current time function iterates using a data tree directed to the selection of a city is spoken by the user.

### FIELD OF THE INVENTION

This invention relates to a digital electronic timekeeping device.

### BACKGROUND OF THE INVENTION

Digital electronic timekeeping devices including clocks and watches, that display local time and date information are well known. Also known are timekeeping devices, radio receivers, and mobile phones that provide time worldwide. For example, timekeeping devices that in response to a manually actuable push button or to manually actuable touch-type selector switches, provide current time for cities in different global time zones, are described by U.S. Pat. No. 4,183,203 to Maezawa et al., U.S. Pat. No. 4,681,460 to Nishimura, and U.S. Pat. No. 5,007,033 to Kubota et al. Kubota et al. also determines and displays date information.

A further example is U.S. Pat. No. 5,724,650 to Shirakawa, which is directed to a radio receiver that includes a time and place display, and selects broadcast frequencies based upon time data. Another example is U.S. Publication No. 2003/0013494 to Imura, which is directed to an apparatus such as a mobile phone that includes a time display that shows both Greenwich Mean Time (GMT) and local time, and that automatically changes the displayed local time to reflect a change in the user's time location. U.S. Publication No. 2003/0193583 to Shimakura is directed to a video camera that visually displays GMT.

Also known is technology directed to performing time zone-related calculations. An example is U.S. Publication No. 2002/0122355 to Williams, which is directed to a time zone database structure for performing time zone-related calculations.

However, none of this timekeeping prior art is based on speech recognition technology. On the other hand, speaker dependent or speaker independent speech recognition technology is known, as illustrated by U.S. Pat. No. 5,020,107 to Rohani et al, U.S. Pat. No. 5,790,754 to Mozer et al, U.S. Pat. No. 5,794,205 to Walters et al, U.S. Pat. No. 6,310,833 to Guyett et al, and U.S. Pat. No. 6,665,639 to Mozer et al.

Mozer et al '639 discloses programmable, non-volatile memory in a watch and downloading language specific information from the Internet to the memory, and that watches with infra-red interfaces are known. Mozer et al '639 also describes speaker independent speech recognition apparatus with multiple applications, that includes an external interface for retrieving new recognition sets from an external medium such as an Internet web site, and that the connection between the external interface and external medium may be an SCSI port, an IDE port, a telephone line, an intranet, a CATV network, the airwaves, and so forth.

Walters et al and Guyett et al describe verbally querying a timekeeping device for current time. In particular, Walters et al disclose a visual display that includes a limited number of time zone annunciators, and that in response to a flashing time zone annunciator being verbally queried, clock time is adjusted and visually displayed in accordance with the flashing time zone annunciator queried. In addition, FIG. 6 of Walters et al discloses digital word libraries that contain addressable word sets stored in Read-Only-Memory (ROM). Limitations of Walters et al include querying for time zone information based upon a limited number of displayed time zones.

There continues to be a longstanding need for a speech recognition-based, digital electronic timekeeping device, and in particular a watch or clock, that would provide a user with time information for a substantially unlimited number of worldwide cities. It would be particularly beneficial for a user to obtain time information for a city of interest with a minimal number of prompts and responses.

### SUMMARY OF THE INVENTION

In accordance with the present invention, there is provided a digital electronic timekeeping device capable of displaying current time information for numerous worldwide locations, and that is based upon speech recognition technology. Accordingly, the inventive device includes a microphone in input communication with a speech recognition processor for receiving audio input.

In accordance with the invention, the timekeeping device also includes a programmable microcontroller in electronic communication with the speech recognition processor, and with a display for displaying information to a user. The timekeeping device includes memory in electronic communication with the programmable microcontroller and the speech recognition processor. Advantageously stored in the memory as digital information are program code for implementing an algorithm for operating the timekeeping device, displayable user interface information, a GMT Offset Data Structure as later defined, and a plurality of speech recognition templates that includes a speech recognition template for a spoken worldwide location, that includes a plurality of randomly accessible city entries. The algorithm includes a plurality of steps for a worldwide current time function.

In one aspect of the invention, the algorithm for the worldwide current time function advantageously includes a hierarchical order of the speech recognition templates directed to the selection of a city spoken by the user. In another aspect of the invention, the algorithm for the worldwide current time function beneficially iterates using a data tree directed to the selection of a city spoken by the user.

The timekeeping device may further include an actuating mechanism for signaling the microcontroller to change the timekeeping device from normal clock function, and may also signal the microcontroller to execute the worldwide current time function.

Beneficially, the algorithm may further include steps for a functional mode selection function, and the speech recognition templates may further include a functional modes speech recognition template that includes a plurality of function entries. In this case, an actuating mechanism may be used to signal the microcontroller to change the timekeeping device from normal clock function, and to signal the microcontroller to execute the functional mode selection function; and audio input consistent with a function entry of the functional modes speech recognition template, may initialize execution of an algorithm for worldwide current time function, which beneficially allows a user to, by speaking, choose a particular node of the data tree to obtain desired time information. As a result, a user may advantageously obtain time information for a city of interest with a minimal number of prompts and verbal responses.

Beneficially, the memory includes flash memory, and the timekeeping device further includes an external interface in electronic communication with the programmable microcontroller and the memory, for receiving digital information from an external information source, and the programmable microcontroller may update the flash memory with the digital information received from the external information source. The digital information received and stored, may include data of the displayable user interface information, data of the GMT Offset Data Structure and data of the speech recognition templates. In the case of the algorithm for the worldwide current time function that iterates using the data tree, the digital information received and stored, may beneficially include data of the data tree, and may advantageously change the hierarchical order of nodes.

In accordance with a feature of the invention, the speech recognition templates may include a trigger phrase speech recognition template. In this case, when the timekeeping device is in the worldwide current time function, a spoken trigger phrase consistent with the trigger phrase speech recognition template, beneficially initiates the display to display a worldwide location prompt selected from the displayable user interface information.

Additional advantages and beneficial features of the present invention are set forth in the drawing and is detailed description, and in part will become apparent to those skilled in the art upon examination of the drawing and detailed description or may be learned by practice of the invention. In the drawing and detailed description, there are shown and essentially described only preferred embodiments of this invention, simply by way of illustration of the best mode contemplated of carrying out this invention. As will be realized, this invention is capable of other and different embodiments, and its several details are capable of modification in various respects, all without departing from the invention. Accordingly, the drawing and the detailed description are to be regarded as illustrative in nature, and not as restrictive.

### BRIEF DESCRIPTION OF THE DRAWING

Reference is now made to the accompanying drawing which forms a part of the specification of the present invention, and is directed to illustrative preferred embodiments of the present invention.

FIG. 1 is a simplified schematic block diagram of a timekeeping device in accordance with the present invention, that illustrates the timekeeping device in a normal clock function mode and local time information including date information being displayed;

FIG. 2 is a simplified schematic block diagram of a variation of the timekeeping device of FIG. 1, that illustrates the device in an inventive Worldwide Current Time Function and corresponding Tokyo time information including date information being displayed;

FIG. 3 illustrates a hierarchical data structure useful by an algorithm for an inventive Worldwide Current Time Function; and

FIG. 4 provides examples based upon using an algorithm with a functional mode selection function.

### DETAILED DESCRIPTION OF THE INVENTION

As can be understood by one skilled in the art, calculation and display of current time information for worldwide cities in accordance with the present invention, is applicable not only to timekeeping devices such as watches and clocks, but is useful in combination with a wide variety of electronic devices such as radios, televisions, telephones including mobile phones, personal digital assistants (PDAs), calculators, video cameras, automated teller machines (ATMs), facsimile machines, and otherwise non-electronic devices such as refrigerator magnets.

For purposes of this description of the present invention, by the phrase “Local Time GMT Offset” is meant the time difference between Greenwich Mean Time (GMT) and local time. This time difference is generally a difference of hours such as a 3 hour or a 12 hour time difference. However, for some geographic locations such as Kabul, Afghanistan, the time difference is a difference of hours and one-half hour. Additionally, for other geographic locations such as Katmandu, Nepal, the time difference is a difference of hours and one-fourth hours.

For purposes of this description of the present invention, by the phrase “GMT Offset Data Structure” is meant the information that specifies the time differences between GMT and various worldwide geographic locations. Because for some geographic locations, time differences from GMT vary seasonally (for example, daylight savings time may be used), or because time differences from GMT can be changed legislatively or otherwise, the GMT Offset Data Structure advantageously includes time difference information that depends upon, or takes into account, seasonal changes, and furthermore is beneficially modifiable so that time differences from GMT are updatable to correspond to time difference changes effective for any reason legislative or otherwise.

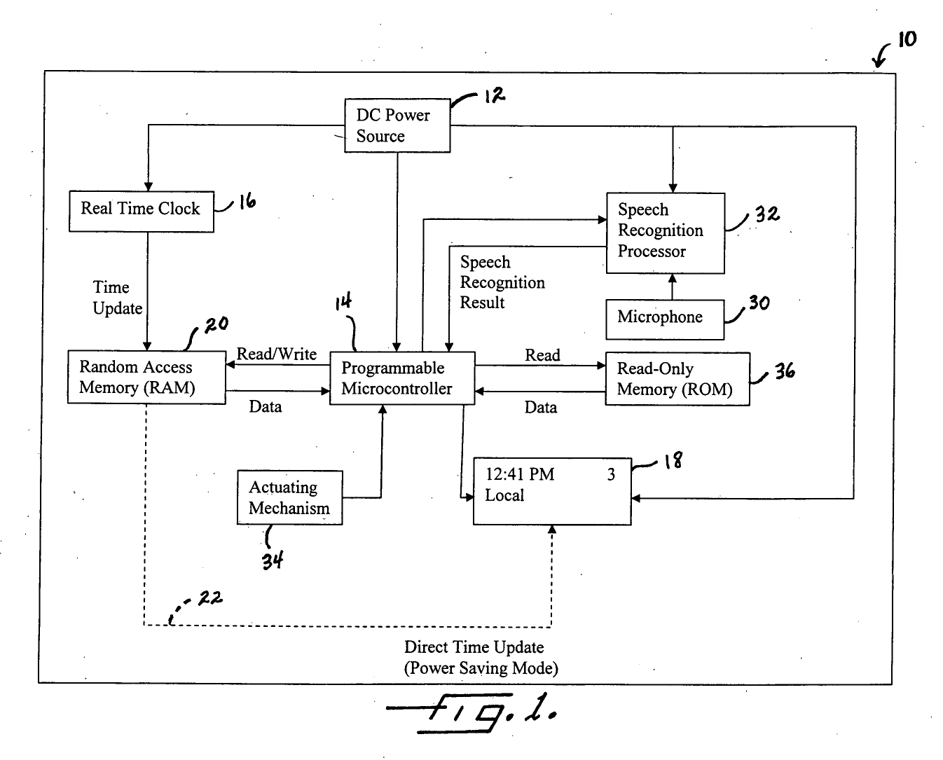

With reference to FIG. 1, a timekeeping device 10 in accordance with the present invention, in particular a watch, is powered by a suitable DC power source 12 such as a watch battery. In applications such as in conjunction with AC powered, digital electronic devices such as radios, televisions, and facsimile machines, AC power operating the digital electronic device is converted to DC power and beneficially used for operation of the technology of the present invention, such that power source 12 remains a DC power source.

With continued reference to FIG. 1, for normal clock function, timekeeping device 10 beneficially may include a programmable microcontroller 14 in electronic communication with a real time clock 16 and a visual display 18 such as an LCD display. Microcontroller 14 and real time clock 16 may each beneficially be provided with Random Access Memory (RAM), represented for simplicity in FIG. 1, as RAM 20.

To provide for calculation and display of current local time information, current time in Greenwich Mean Time (GMT) may be stored in real time clock RAM 20, and the Local Time GMT Offset may be determined from the GMT Offset Data Structure and stored in microcontroller RAM 20. In such case, at an appropriate frequency of for instance once per second, current GMT time is electronically communicated from the real time clock RAM to the microcontroller, which is conveniently programmed to calculate current local time information as the mathematical sum of current GMT time plus the Local Time GMT Offset. In conjunction therewith, display 18 is updated by the microcontroller to display current local time information, which as illustrated by FIG. 1 beneficially may include date information (the number “3” is the day of the month). Advantageously, with further reference to display 18, the display may also display location information, including the word “LOCAL”, or if desired, the name of the local city.

Alternatively, to reduce power consumption when power source 12 is a battery, or for another commercially advantageous reason or reasons, the microcontroller may after calculation thereof, electronically communicate current local time information to real time clock RAM 20, and the real time clock keeps track of current local time information, the microcontroller goes into a power consumption-saving sleep mode, and display 18 may be updated to display current local time information as indicated by a phantom line 22. Using this variation, mathematical calculation of current local time information is not needed after the microcontroller goes into the sleep mode, and battery power consumption by the microcontroller may be significantly reduced.

As will be understood by one skilled in the art and is illustrated in the description that follows, other power consumption-saving modifications within the scope of the present invention, are feasible. Furthermore, as one skilled in the art will perceive, although FIG. 1 shows the real time clock and microcontroller as separate components, numerous electronic component variations from the components illustrated in FIG. 1 are feasible and within the scope of the present invention. For example, the microcontroller could function as the real time clock.

With continued reference to the timekeeping device of FIG. 1, to provide for a worldwide specific location current time function in accordance with the present invention (“Worldwide Current Time Function”), timekeeping device 10 beneficially additionally includes a microphone 30 in input communication with a suitable speech recognition processor 32 with a speaker independent speech recognition mode, and may also include an actuating is mechanism 34 such as a push button, to change the timekeeping device from normal clock function to an inventive Worldwide Current Time Function, or serve other useful purposes. As illustrated by FIG. 1, speech recognition processor 32 and actuating mechanism 34 are in electronic communication with microcontroller 14. When used, actuating mechanism 34 is advantageously used to signal microcontroller 14.

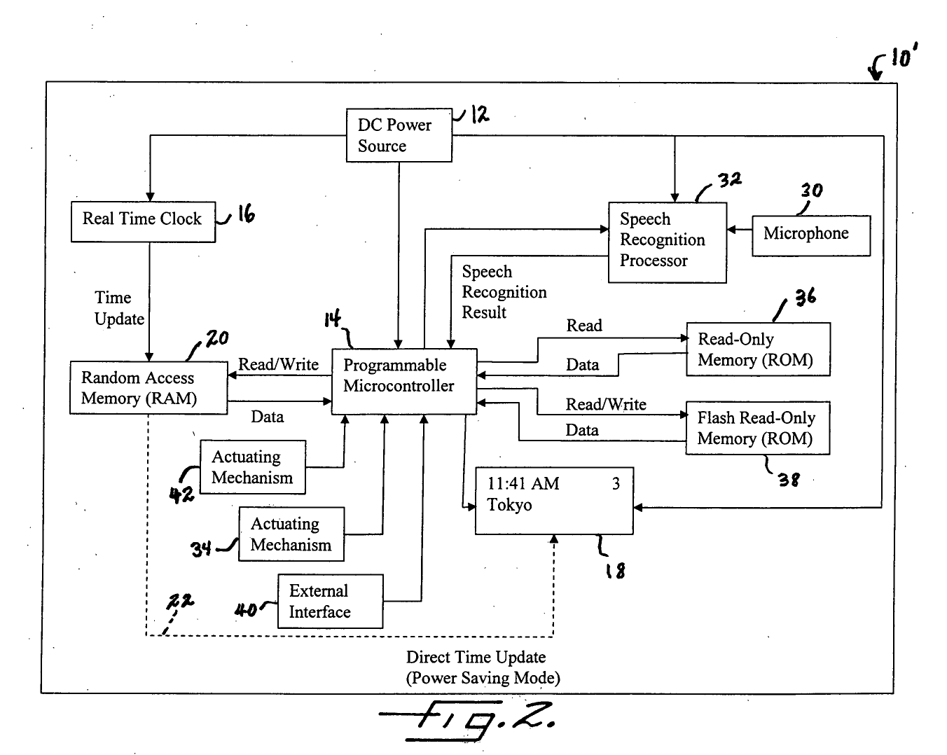

A variety of actuating mechanisms may be used. For example, actuating mechanism 34 may be a manually actuable mechanism such as a push button or toggle switch or touch-type selector switch, or may be a photooptical actuating mechanism such as a photocell covered by a removably attached light-blocking cover. Furthermore, the device may include a plurality of other actuating mechanisms, for instance, an actuating mechanism 42, shown in FIG. 2, which may be manually actuable such as a push button, for changing the timekeeping device to normal clock function, or for other useful purposes.

Instead of using an actuating mechanism such as a mechanical or photooptical actuating mechanism, the speech recognition processor could operate in a substantially continuous listening mode, and in response to an appropriate audio event or command, signal the microprocessor to change the timekeeping device from one function to another function in accordance with the present invention. However, a drawback for a battery powered timekeeping device would be the increased power consumption required to maintain the speech recognition processor in a listening mode. Furthermore, using an actuating mechanism instead of an audio event or audio command to generate a signal, reduces the likelihood of unintended function change, as a result of inadvertent use, or occurrence, of a triggering audio event or command. Accordingly, using an actuating mechanism to signal the microprocessor can be advantageous.

Useful chips that include a suitable speech recognition processor with a speaker independent speech recognition mode, an optional real time clock, and a suitable programmable microcontroller in electronic communication with one another, are commercially available. A currently preferred example is the RSC-4128 Speech Recognition Processor (SRP) chip sold by Sensory, Inc., Sunnyvale, Calif. The RSC-4128 chip includes the ability to address off-chip memory including RAM, Read-Only-Memory (ROM), Flash ROM, and EPROM, a type of Flash ROM, and includes two lower power modes.

With continued reference to the embodiment of FIG. 1, speech recognition processor 32, microcontroller 14, and Read-Only-Memory (ROM) 36 are shown as separate components in electronic communication with one another. ROM 36 may be located on the speech recognition processor chip, or, as indicated, off the speech recognition processor chip, or on the speech recognition processor chip and another chip or chips, as appropriate or desired depending upon commercial advantage, engineering efficiency, power demand and the like. For purposes of describing this invention, ROM 36, after being programmed, is called “Burnt ROM”. Beneficially stored in Burnt ROM is the program code for normal clock function and for functions in accordance with the present invention.

In accordance with a modification of timekeeping device 10 of FIG. 1, and referring again to FIG. 2, a timekeeping device 10′ in accordance with the present invention, may advantageously also be provided with Flash ROM 38, which is updatable, and also with an external interface 40 in communication with a microcontroller 14 for updating RAM 20 and Flash ROM 38. For brevity of this description of timekeeping device 10′, the previously used numbering is used to designate like features of device 10′, it being understood that reference can be made to the description of timekeeping device 10 for understanding.

Beneficially stored in Flash ROM 38 is data of the GMT Offset Data Structure to allow, as earlier indicated, time differences from GMT to be updatable. External interface 40 advantageously provides for updating data, and for receiving any other desired digital information from an external information source such as an Internet web site.

Useful external interfaces for a watch, include an infra-red interface and an appropriate physical interface such as a serial port and a USB port. In the case of an infra-red interface, communication between the interface and external information source is advantageously wireless. Useful external interfaces for large-sized digital electronic devices with which the inventive timekeeping technology may be advantageously used, additionally may include physical interfaces such as an SCSI port, an IDE port and a network port.

Also stored in memory (ROM 36 or Flash ROM 38, as desired or appropriate) of a timekeeping device in accordance with the present invention, are displayable user interface information including Prompts and Messages, which may be constant value Prompts and Error Messages, and other Messages, and digital word libraries including speech recognition templates, which advantageously may be language specific, and which are used by functions in accordance with the present invention. Although timekeeping devices in accordance with the present invention, may be manufactured and sold with language specific data stored in Burnt ROM, the use of an external interface to receive, and of Flash ROM to store, language specific data may be commercially beneficial to avoid the manufacture of timekeeping devices that vary from one another with respect to language specific data depending upon the country into which shipment and sale is intended.

It may also be commercially advantageous for large digital word libraries such as speech recognition templates, to be stored in the memory (ROM 36 or Flash ROM 38, as desired or appropriate) of another chip than that of a speech recognition processor chip. As appropriate or desired depending upon commercial advantage, engineering efficiency, power demand and the like, a variety of commercially available chips exists that can be selected from and assembled to make a timekeeping device in accordance with the present invention.

The displayable user interface information and speech recognition templates are advantageously program configurable data utilized by functions in accordance with the present invention. A wide variety of suitable choices are available and may be selected from. Exemplary displayable English language Prompts include “WHAT FUNCTION?”, “WHAT TIME PLEASE MODE?”, “WHAT FAMOUS CITY?”, “WHAT SECONDARY CITY?”, “WHAT CITY & COUNTRY?”, “WHAT REGION?”, “WHAT COUNTRY?”, “WHAT STATE?”, “WHAT PROVINCE?”, and “WHAT CITY?”. Illustrative displayable English language Messages include “INVALID FUNCTION”, “INVALID FAMOUS CITY”, “INVALID SECONDARY CITY”, “INVALID CITY & COUNTRY”, “INVALID REGION”, “INVALID COUNTRY”, “UNABLE TO RECOGNIZE”, and “TRY AGAIN”.

By the term “Region” is meant for purposes of this description, a geographical area such as Western Europe, Eastern Europe, Africa, United States, and Canada, and conveniently or arbitrarily grouped geographical areas and designations such as Middle East, Central Asia, and India; Southeast Asia, Pacific Asia, China, South Pacific and Australia; and Latin America, Caribbean and South America. For conveniently or arbitrarily grouped geographical areas and designations, the set of cities is advantageously the same whether, for example, a user says “Middle East” or “Central Asia” or “India”. Thus, use of conveniently or arbitrarily grouped geographical areas increases a user's probability of obtaining desired time information without certainty as to geography. Other convenient or arbitrary groupings may be used.

In accordance with an inventive Worldwide Current Time Function, the speech recognition templates include at least one speech recognition template for a spoken worldwide location, and may beneficially include a trigger phrase speech recognition template. Advantageously, a speech recognition template for a spoken worldwide location may be a city template that includes a set of randomly accessible city entries, a city and country template that includes a set of randomly accessible city and country entries, a Region template that includes a set of randomly accessible Region entries, a country template that includes a set of randomly accessible country entries, a city by Region template, a country by Region template, a city by country template, a state by country template, or a city by province template, or a city by state template or the like for countries with many cities of the same name such as the United States, used in combination as appropriate or desired. Sets of entries may advantageously be indexed.

A city template that includes a set of famous city entries, may be particularly used with advantage. By “famous cities” is meant for purposes of this description, world-renowned cities such as New York, Rio de Janeiro, London, Paris, Madrid, Cairo, Rome, Athens, Prague, Jerusalem, Baghdad, Moscow, New Delhi, Sydney, Bangkok, Beijing, Manila, Hong Kong, Tokyo and Honolulu. With a famous cities template, a user may obtain desired time information by responding to the English language Prompt “WHAT FAMOUS CITY?” by simply speaking a city name.

A secondary cities template that includes a set of relatively less famous city entries, may be advantageously used in hierarchical combination with, or as an alternative to, a famous cities template. Secondary city entries may include in indexed order Vancouver, Lima, Seville, Rheims, Hamburg, Nairobi, and Osaka. In this illustrative indexed order, Vancouver corresponds to index 1, Lima corresponds to index 2, Seville corresponds to index 3, Rheims corresponds to index 4, and so forth. A secondary cities template may be conveniently used with the English language Prompt “WHAT SECONDARY CITY?”.

A country template that includes a set of major country entries, may be used in hierarchical combination with a famous cities template, and, if desired, also in combination with the secondary cities template, or as an alternative to either template. Major country entries may include United States, Canada, Mexico, Brazil, England, Ireland, Scotland, Denmark, Norway, Sweden, Spain, Germany, Austria, Switzerland, France, Italy, Greece, Turkey, Saudi Arabia, Israel, Egypt, South Africa, Russia, Australia, New Zealand, Malaysia, Philippines, India, China and Japan. A major country template may be conveniently used with the English language Prompt “WHAT MAJOR COUNTRY?”, and with an appropriate City by Major Country template to obtain the desired time information.

As previously described, the program code for an algorithm in accordance with the inventive technology, may be stored in burnt ROM. The algorithm for an inventive Worldwide Current Time Function may include a hierarchical order of speech recognition templates, or may iterate using a data structure that allows definition of a hierarchical order of nodes, that in combination with appropriate Prompts leads a user to obtain desired time information. Exemplary is a hierarchical order of speech recognition templates that begins with a famous cities template. If in response to the Prompt “WHAT FAMOUS CITY?”, a user speaks a city name that is not included as a “famous city” entry in a famous cities template, an Error Message such as “INVALID CITY” may be displayed, and may thereafter be followed by the Prompt “WHAT SECONDARY CITY?”.

If in response to the Prompt “WHAT SECONDARY CITY?”, a user speaks a city that is included as an entry in a secondary cities template, desired time information for the spoken City is displayed. Otherwise, an appropriate speech recognition template may be used next in combination with an appropriate Prompt. For example, the Prompt “WHAT REGION?” may be displayed next, for use in combination with a Region template.

An advantageous city by Region template or city by country template or city by state template includes an indexed set of randomly accessible city entries for cities located within the Region or country or state, as the case may be. A beneficial city and country template similarly includes an indexed set of randomly accessible city entries.

As indicated, the speech recognition templates may be combined in a variety of ways. Exemplary is a hierarchical order of speech recognition templates that begins with, or includes, a Region template or country template. Combinations include a Region template in combination with a plurality of city by Region templates; or a Region template in combination with a plurality of country by Region templates each including a set of randomly accessible country entries, and in combination with a plurality of city by country templates; and include a country template in combination with a plurality of city by country templates; or a country template in combination with a plurality of state by country templates each including a set of randomly accessible state entries, and in combination with a plurality of city by state templates.

Appropriate Prompts may include “WHAT REGION?”, “WHAT COUNTRY?”, “WHAT STATE?”, and “WHAT CITY?”. A Region or country or state entry of a Region or country or state template, as the case may be, that is consistent with a Region or country or state spoken in response to an appropriate Prompt advantageously results in selection of the appropriate city by Region template or country by Region template or city by country template or state by country template or city by state template from among a plurality of city by Region templates or from among a plurality of country by Region templates or from among a plurality of city by country templates, or from among a plurality of state by country templates, or from among a plurality of city by state templates. If in response to the Prompt “WHAT CITY?”, a user speaks a city name that is included as an entry in the selected city by Region or city by country or city by state template, desired time information for the spoken city is displayed.

For purposes of illustrating an algorithm in accordance with the inventive technology in detail, an algorithm that includes a hierarchical template order that begins with a Region template and includes a plurality of City By Region templates, is described. With reference to FIGS. 1 and 2, when speech recognition processor (SRP) 32 is in the listening mode and waiting for the result of speaker independent speech recognition, subsequent to a signal to “Execute Worldwide Current Time Function”, and subsequent to microcontroller 14 powering up SRP 32, and commanding SRP 32 to advantageously begin speaker independent speech recognition, and communicating to SRP 32 the ROM address of the trigger phrase speech recognition template, an illustrative program configurable trigger phrase to be spoken is “TIME PLEASE”.

SRP 32 receives audio input from microphone 30 and compares the audio input with the trigger phrase speech recognition template. If audio input consistent with the trigger phrase speech recognition template is received, then SRP 32 returns a positive result and control to microcontroller 14, which then proceeds to the first iterative sequence.

However, if audio input consistent with the trigger phrase template is not received within a predetermined number of seconds (otherwise sometimes called, for purposes of this description, a “timeout period”), then SRP 32 returns control and a negative result to microcontroller 14. The microcontroller then returns SRP 32 to a power down mode, terminates the Worldwide Current Time Function, and the timekeeping device returns to normal clock function.

In Step 1 of the first iterative sequence, the microcontroller retrieves a Region Prompt from memory, and updates display 18 to display “WHAT REGION?”. In Step 2, the microcontroller again commands SRP 32 to beneficially begin speaker independent speech recognition, and communicates to SRP 32 the ROM address of the randomly accessible, Region speech recognition template, and begins waiting for the result of speaker independent speech recognition.

In Step 3 of the first iterative sequence, SRP 32 receives audio input from microphone 30 and compares the audio input for consistency with any entry of the randomly accessible Region entries of the Region speech recognition template. If the audio input is consistent with an entry of the Region template, then SRP 32 returns data representing that Region entry, and returns control, to microcontroller 14. The microcontroller then stores the data representing the spoken Region in RAM 20, sets the current failure count stored in RAM to zero, and proceeds to the second iterative sequence.

However, if the audio input is not consistent with an entry of the Region template or an error condition is encountered (for example, invalid Region spoken, unable to recognize Region spoken, or other error) then SRP 32 returns a negative result including a program-code appropriate error code, along with control, to the microcontroller. The microcontroller increments the current failure count stored in RAM, retrieves the appropriate Error Message such as “INVALID REGION” or “UNABLE TO RECOGNIZE”, from memory, and updates display 18 with the Error Message, and waits for an appropriate predetermined period of seconds while displaying the Error Message.

If the current failure count for the first iterative sequence exceeds a predetermined appropriate limit, microcontroller 14 sets the current failure count to zero, returns SRP 32 to a power down mode, terminates the Worldwide Current Time Function, and the timekeeping device returns to normal clock function.

If the current failure count for the first iterative sequence does not exceed a predetermined appropriate limit, the microcontroller retrieves a “TRY AGAIN” prompt from memory, and updates display 18 with the “TRY AGAIN” prompt, and waits for an appropriate predetermined period of seconds while displaying the “TRY AGAIN” prompt, after which the microcontroller returns to Step 1 of the first iterative sequence, and display 18 is updated to again display “WHAT REGION?”.

In Step 1 of the second iterative sequence, the microcontroller retrieves a City Prompt from memory, and updates display 18 to display “WHAT CITY?”. In Step 2, the microcontroller again commands SRP 32 to beneficially begin speaker independent speech recognition, and communicates to SRP 32 the ROM address of the randomly accessible, City By Region speech recognition template associated with the identity of the Region entry stored as data in RAM 20 in Step 3 of the first iterative sequence, and begins waiting for the result of speaker independent speech recognition.

In Step 3 of the second iterative sequence, SRP 32 receives audio input from microphone 30 and compares the audio input for consistency with any entry of the randomly accessible City entries of the appropriate City By Region speech recognition template. If the audio input is consistent with an entry of the City by Region template, then SRP 32 returns data representing that City entry, and returns control, to microcontroller 14. The microcontroller then stores the data representing the spoken City in RAM 20, sets the current failure count stored in RAM to zero, and proceeds to the GMT offset determination and result display sequence.

However, if the audio input is not consistent with an entry of the City by Region template or an error condition is encountered, then the algorithm proceeds in like manner as described with respect to the first iterative sequence, with the algorithm returning to the first Step of the second iterative sequence or with the Worldwide Current Time Function being terminated.

In the first Step of the GMT offset determination and result display sequence, the microcontroller uses the data representing the spoken City to select the GMT offset, and as necessary, adjusts the GMT offset according to any date-based offset adjustment rules associated with the spoken City. In Step 2, the microcontroller retrieves current GMT time from RAM 20. In Step 3 of the GMT offset determination and result display sequence, the microcontroller computes current time information for the spoken City as the mathematical sum of current GMT time plus the GMT offset of the spoken City as determined in the first Step. If the calculated time is less than 0:00:00, then the date to be displayed is adjusted back one day. On the other hand, if the calculated time is greater than 23:59:59, then the date to be displayed is adjusted forward one day.

In the subsequent Steps of the GMT offset determination and result display sequence, the microcontroller updates display 18 with current time information for the spoken City, including current date information, the microcontroller returns SRP 32 to a power down mode, the microcontroller displays the Worldwide Current Time Function result for a appropriate predetermined number of seconds, and the microcontroller terminates the Worldwide Current Time Function, and the timekeeping device returns to normal clock function.

For purposes of illustrating a particularly advantageous embodiment of the invention, an overview of an algorithm that uses Functional Mode Selection and a Functional Modes speech recognition template that includes a plurality of function entries, is described. With reference to FIGS. 1 and 2, when speech recognition processor 32 is in the listening mode subsequent to a signal to “Execute Functional Mode Selection Function”, display 18 may be updated to display a Prompt such as “WHAT FUNCTION?”.

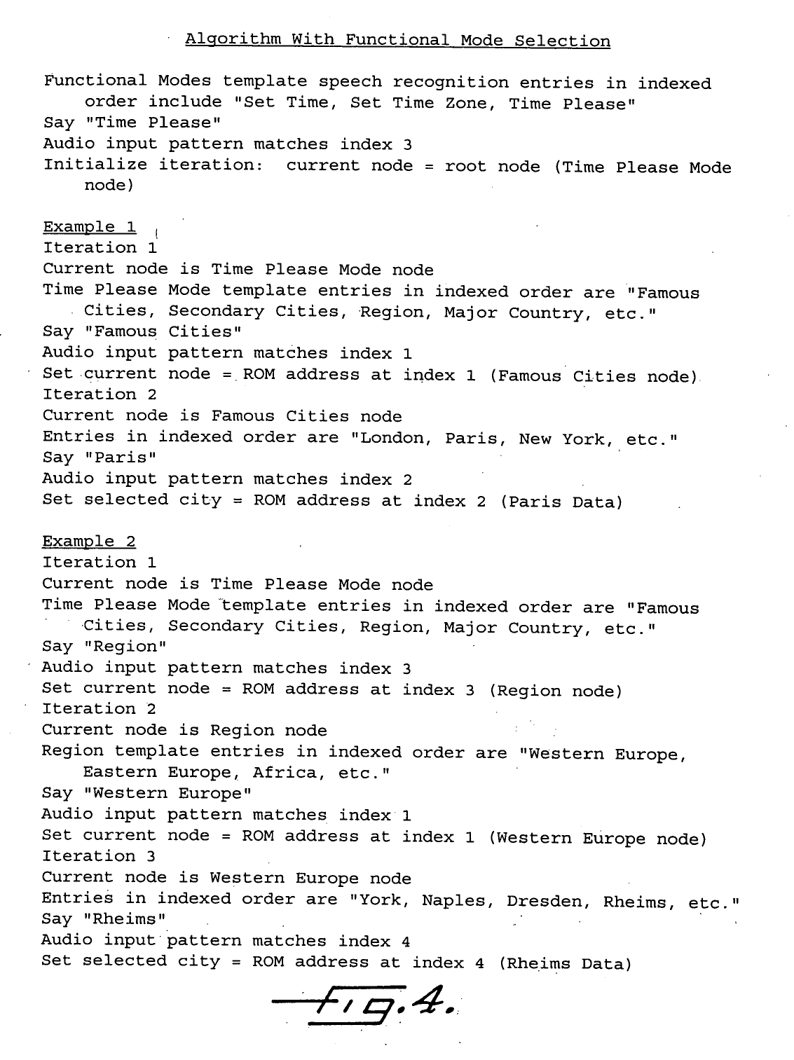

With reference also to FIG. 4, subsequent to microcontroller 14 commanding the speech recognition processor to advantageously begin speaker independent speech recognition, appropriate function phrases to be spoken may include “SET TIME” to begin execution of a function to set the local time, “SET TIME ZONE” to begin execution of a function to set the time in accordance with the local time zone as defined by a spoken City, and “TIME PLEASE” to advantageously initialize iteration of a Generic Algorithm as subsequently described in detail.

In response to the phrase “TIME PLEASE”, a Prompt such as “WHAT TIME PLEASE MODE?” may be displayed. An illustrative Time Please Mode speech recognition template may include a randomly accessible indexed set of entries such as “Famous Cities”, “Secondary Cities”, “City and is Country”, “Region” and “Major Country”. A user may respond to the Prompt by speaking any of the entries of the Time Please Mode template, for example, by saying, “SECONDARY CITIES”, and thereby select the “Secondary Cities” entry.

Alternatively, the function entries of a Functional Modes speech recognition template, and audio input consistent with a function entry of the template, may initialize iteration of a Generic Algorithm and selection of an entry for obtaining time information for a city of interest. For example, the Functional Modes speech recognition template may omit a “Time Please” entry, and include Time Please Mode speech recognition template entries. As a result, iteration of a Generic Algorithm and selection of an entry may be initiated by speaking a phrase corresponding to the Time Please Mode template entries such as “FAMOUS CITIES” or “REGION”.

In any event, an algorithm that uses Functional Mode Selection or the like, allows a user to obtain desired worldwide time information with minimal prompts and verbal responses, by beginning an inquiry with an appropriate choice for a city of interest depending upon whether a city of interest is a famous city, or other considerations including that a particular city name is used in more than one country, or in more than one state or province or the like, of a country.

It may be commercially advantageous for program configurable speech recognition templates, and for program configurable, displayable user interface information such as “WHAT FAMOUS CITY?”, “WHAT MAJOR COUNTRY?”, “UNABLE TO RECOGNIZE” and “TRY AGAIN” not only to be language specific, but also to be updatable by use of an external interface. Thus, entries within speech recognition templates may be changed. For example, different users may want a famous cities template to contain different entries.

Furthermore, as previously indicated, sequential prompting such as “WHAT MAJOR COUNTRY?” followed by a sub-country Prompt such as “WHAT STATE?” (in the case of the United States) or “WHAT PROVINCE?” (in the case of Canada) followed by “WHAT CITY?”, may be used in combination with a hierarchical order of speech recognition templates based upon a major country template, and then a plurality of state by country or province by country templates, and then a plurality of city by state or city by province templates.

Moreover, the algorithm may provide for a user to query “TIME PLEASE PARIS”, and for microcontroller 14 to respond by updating display 18 with current time information for Paris. In this variation, the algorithm may provide for the speech recognition processor to determine if the audio input is consistent with a speech recognition template that includes randomly accessible entries of “Time Please” and famous cities in combination.

If a user does not succeed in obtaining the desired time information after, for instance, a predetermined number of attempts, a timekeeping device in accordance with the invention and display 18 may in accordance with the algorithm, automatically return to normal clock function. Alternatively, or in addition, after a predetermined period of time in a Worldwide Current Time Function without success (including from lack of a timely verbal response), a timekeeping device in accordance with the invention and display 18 may in accordance with the algorithm, automatically return to normal clock function. Alternatively, or in addition, an actuating mechanism 42, shown in FIG. 2, may be, for example, manually actuated to return a timekeeping device in accordance with the invention, to normal clock function.

Algorithm Utilizing a Data Tree

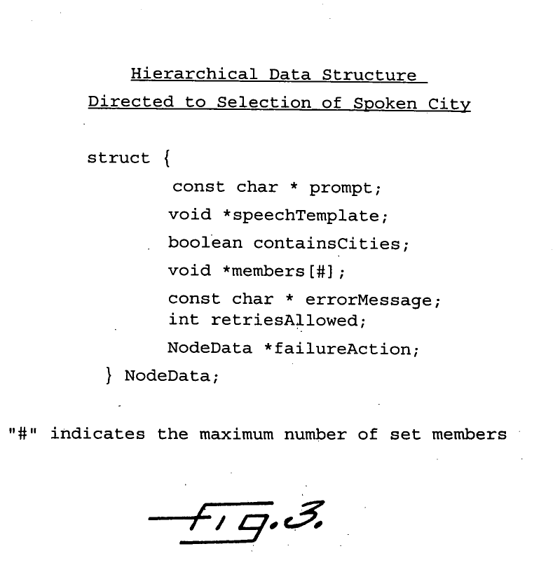

The algorithm for an inventive Worldwide Current Time Function may beneficially iterate using a data tree directed to the selection of a City spoken by the user. (“Generic Algorithm”), as illustrated in FIG. 3.

With reference specifically to the hierarchical data structure illustrated in FIG. 3, by the term “NodeData” is meant the definition of an instance of a data node of a tree containing a plurality of NodeData instances directed to, for purposes of this invention, the selection of a City spoken by the user. The NodeData of FIG. 3 advantageously contains seven data structure members of information as follows:

1. The ROM address of the Prompt to display when this instance of NodeData (or node) is selected to be evaluated by the current iteration of the Generic Algorithm.

2. The ROM address of the Speech Recognition Template to communicate to the Speech Recognition Processor when this node is selected to be evaluated by the current iteration of the Generic Algorithm.

3. A boolean value (true or false) that defines whether this NodeData instance is a final node of the tree, that is, whether the containsCities value is true.

4. An advantageously indexed set of randomly accessible references to other memory locations. If the containsCities value is true, then this indexed set of references is to the randomly accessible ROM addresses of entries within the GMT Offset Data Structure from which the ROM address of the entry associated with the City spoken is selected. If the containsCities value is false, then this indexed set of references is to randomly accessible ROM addresses of other instances of NodeData from which to select the node for evaluation by the next iteration of the Generic Algorithm.

5. The ROM address of the constant value message to display if the audio input is not consistent with an entry of the Speech Recognition Template evaluated by this instance of NodeData.

6. For this instance of NodeData, the maximum number of retries allowed to obtain pattern matching. Setting to zero will allow only one attempt to obtain pattern matching. Setting to one will allow one attempt and one retry. The setting is arbitrary. A relatively higher number of retries allowed, permits more user error.

7. The ROM address of NodeData instance to evaluate by the next iteration of the Generic Algorithm if the number of allowable retries for this iteration of the algorithm, in particular this node, is exceeded.

With reference to FIGS. 1 and 2, and the hierarchical data structure of FIG. 3, microcontroller 14 begins execution of the Generic Algorithm after receiving an “Execute Generic Worldwide Current Time Function” signal for example, from a manual actuation event using actuating mechanism 34 by depression of a push button once. In Step 1, programmable microcontroller 14 (“PM”) powers up speech recognition processor 32. In Step 2, microcontroller 14 commands speech recognition processor (SRP) 32 to begin speaker independent speech recognition, and communicates the ROM address of the Trigger Phrase speech recognition template (an illustrative Trigger Phrase to be spoken is again “TIME PLEASE”) to SRP 32, and begins waiting for the result of speaker independent speech recognition.

In Step 3, SRP 32 receives audio input from microphone 30 and compares the audio input with the Trigger Phrase speech recognition template. If audio input consistent with the Trigger Phrase template is received, then SRP 32 returns control and a positive result to microcontroller 14. If the result returned to the microcontroller is a positive result, then the microcontroller proceeds to Step 4.

However, if audio input consistent with the Trigger Phrase template is not received within a timeout period, then SRP 32 returns control and a negative result to microcontroller 14. The microcontroller then returns SRP 32 to a power down mode, terminates execution of the Generic Algorithm, and the timekeeping device returns to normal clock function.

In Step 4, to initialize iteration of the Generic Algorithm, the microcontroller sets the value of the NodeData pointer that stores in RAM, the ROM (ROM 36 or Flash ROM 38) address of the NodeData instance to be evaluated by a first iteration of the Generic Algorithm, to the ROM address of the root node. The root node is the entry point into the data tree.

In Step 5, to iterate the Generic Algorithm, the microcontroller retrieves the Prompt referenced by the NodeData instance being evaluated, from memory, and updates display 18 to display the Prompt. In Step 6, the microcontroller again commands SRP 32 to begin speaker independent speech recognition, and communicates to SRP 32 the ROM address of the randomly accessible, speech recognition template referenced by the NodeData-instance being evaluated, and begins waiting for the result of speaker independent speech recognition.

In Step 7, SRP 32 receives audio input from microphone 30 and compares the audio input for consistency with any entry of the randomly accessible entries of the speech recognition template referenced by NodeData instance being evaluated. If the audio input is consistent with an entry of the template being evaluated, then SRP 32 returns the index of that entry, and returns control, to microcontroller 14. The microcontroller then sets the current failure count stored in RAM to zero, and if the containsCities value is true, the microcontroller sets the value of the selected City GMT Offset Data pointer stored in RAM, to the value, which is a ROM address, associated with the returned index, and proceeds to Step 8.

If the containsCities value is false, the microcontroller sets the value of the NodeData pointer to the value, which is a ROM address, associated with the returned index, thereby setting the value of the NodeData pointer to the ROM address of the next NodeData instance to be evaluated, and begins the next iteration of the Generic Algorithm by returning to Step 5.

However, if the audio input is not consistent with an entry of the template or an error condition is encountered (for example, invalid City spoken, unable to recognize City spoken, or other error) then SRP 32 returns a negative result including a program-code appropriate error code, along with control, to the microcontroller. The microcontroller increments the current failure count stored in RAM, retrieves the appropriate Error Message referenced by the NodeData instance being evaluated, such as “INVALID CITY” or “UNABLE TO RECOGNIZE”, from memory, and updates display 18 with the Error Message, and waits for an appropriate predetermined period of seconds while displaying the Error Message. If desired, the microcontroller may retrieve a try again Message from memory and update display 18 with the try again Message, and wait for an appropriate predetermined period of seconds while displaying the Message.

If the current failure count does not exceed the retries allowed for the NodeData instance being evaluated, microcontroller 14 returns to Step 5 to retry the current iteration of the Generic Algorithm.

However, if the current failure count exceeds the retries allowed for the NodeData instance being evaluated, microcontroller 14 sets the current failure count to zero, and if the failureAction reference is set to the ROM address of another NodeData instance, microcontroller 14 sets the value of the NodeData pointer to the value of failureAction, thereby setting the value of the NodeData pointer to the ROM address of the next NodeData instance to be evaluated, and begins the next iteration of the Generic Algorithm by returning to Step 5. But if the failureAction reference is not set to the ROM address of another NodeData instance, the microcontroller 14 returns SRP 32 to a power down mode, terminates the Generic Algorithm, and the timekeeping device returns to normal clock function.

With continued reference to FIGS. 1 and 2, and the hierarchical data structure of FIG. 3, in Step 8, using the ROM address stored as the value of the selected City pointer from Step 7, the microcontroller retrieves the data associated with the spoken City from the GMT Offset Data Structure, selects the GMT offset from the retrieved data, and as necessary, adjusts the GMT offset according to any date-based offset adjustment rules associated with the spoken City or included in the retrieved data.

In Step 9, the microcontroller retrieves current GMT time from RAM 20. In Step 10, the microcontroller computes current time information for the spoken City as the mathematical sum of current GMT time plus the GMT offset of the spoken City as determined in Step 8. If the calculated time is less than 0:00:00, then the date to be displayed is adjusted back one day. On the other hand, if the calculated time is greater than 23:59:59, then the date to be displayed is adjusted forward one day.

In Step 11, the microcontroller updates display 18 with current time information for the spoken City, including current date information. With specific reference to display 18 of FIG. 2, the number “4” is date information (day of the month). As illustrated, the name of the spoken city, for example, Tokyo, may also be displayed. If desired, neither date information nor the spoken city may be displayed. If desired, date information including the month and the day of the week, may be displayed.

In Step 12, the microcontroller returns SRP 32 to a power down mode. In Step 13, the microcontroller displays the Generic Algorithm result for an appropriate predetermined number of seconds. In Step 14, the microcontroller terminates the Generic Algorithm, and the timekeeping device returns to normal clock function.

With continued reference to FIGS. 2 and 3, digital information that beneficially includes data that changes the root node, data that changes the hierarchical order of nodes, and data that is used by the data tree, may be received by external interface 40 and stored in memory.

### GENERIC ALGORITHM EXAMPLE 1

As previously described, the Generic Algorithm beneficially iterates using a data structure that allows definition of a hierarchical order of NodeData instances. An advantageous example of a hierarchical order of NoteData instances includes a Region NodeData instance followed by a City By Region NodeData instance selected from a plurality of City By Region NodeData instances.

In this example, after beginning execution of the Generic Algorithm and Steps 1 and 2 thereof, and after a positive result and control are returned to the microcontroller in Step 3 thereof, in Step 4, to initialize iteration of the Generic Algorithm, the microcontroller sets the value of the node pointer to the root node, which is the ROM address of a Region node. In accordance with the hierarchical data structure of FIG. 3, the Region NodeData instance references a Region Prompt, and references a Region template that includes a set of randomly accessible Region entries.

In Step 5, the microcontroller retrieves the Region Prompt from memory, and updates display 18 to display “WHAT REGION?”. Step 6 is as previously described, specifically with communication of the ROM address of the Region template to SRP 32.

Step 7 is as previously described, specifically with the audio input being compared for consistency with any entry of the randomly accessible Region entries of the Region template. If the audio input is consistent with an entry of the Region template, then SRP 32 returns the index of that Region entry, and returns control, to microcontroller 14. The microcontroller sets the current failure count stored in RAM to zero, and because the containsCities value is false for this iteration of Steps 5 to 7, the microcontroller sets the value of the NodeData pointer to the value associated with the returned index, thereby setting the value of the NodeData pointer to the ROM address of the next NodeData instance to be evaluated.

In this example, the next NodeData instance to be evaluated is a City By Region NodeData instance. In accordance with the generic data structure of FIG. 3, the City By Region NodeData instance references a City By Region Prompt, and references an appropriate City By Region template. It can thus be understood that as a result of the audio input being consistent with an entry of the Region template, the appropriate City By Region template is selected from among a plurality of City By Region templates.

In this iteration of Step 5 of the Generic Algorithm, the microcontroller retrieves a City By Region Prompt from memory, and updates display 18 to display “WHAT CITY?”. In this iteration of Step 6, Step 6 is as previously described, specifically with communication to SRP 32 of the ROM address of City By Region template referenced by the NodeData instance being evaluated.

In this iteration of Step 7, Step 7 is as previously described, specifically with the audio input being compared for consistency with any entry of the randomly accessible City entries of the appropriate City By Region template. If the audio input is consistent with an entry of the appropriate City By Region template, then SRP 32 returns the index of that City entry, and returns control, to microcontroller 14. The microcontroller then sets the current failure count stored in RAM to zero, and because the containsCities value is true for this iteration of Steps 5 to 7, the microcontroller sets the value of the selected City GMT Offset Data pointer stored in RAM 20, to the value associated with the index of the spoken City, and proceeds to Step 8.

Step 8 is as previously described, specifically with the microcontroller using the ROM address associated with the spoken City, to retrieve the data associated with the spoken City from the GMT Offset Data Structure, selecting the GMT offset from the retrieved data, and as necessary, adjusting the GMT offset according to any date-based offset adjustment rules. Steps 9 to 14 are as previously described, with display 18 being updated with current time information for the spoken City, including, if desired, current date information.

### GENERIC ALGORITHM EXAMPLE 2

An alternative hierarchical order of nodes that begins with a Famous Cities node, is now exemplified.

In this example, after beginning execution of the Generic Algorithm and Steps 1 and 2 thereof, and after a positive result and control are returned to the microcontroller in Step 3 thereof, in Step 4, to initialize iteration of the Generic Algorithm, the microcontroller sets the value of the node pointer to the root node, which is the ROM address of a Famous Cities node. In accordance with the hierarchical data structure of FIG. 3, a Famous Cities Node Data instance references a famous cities Prompt, and references a famous cities speech recognition template.

In Step 5 of the Generic Algorithm, the microcontroller retrieves the famous cities Prompt from memory, and updates display 18 to display “WHAT FAMOUS CITY?”. Step 6 is as previously described, specifically with communication to SRP 32 of the ROM address of the famous cities template.

Step 7 is as previously described, specifically with the audio input being compared for consistency with any entry of the randomly accessible City entries of the famous cities template. If the audio input is consistent with an entry of the famous cities template, then SRP 32 returns the index of that City entry, and returns control, to microcontroller 14. The microcontroller then sets the current failure count stored in RAM to zero, and because the containsCities value is true, the microcontroller sets the value of the selected City GMT Offset Data pointer stored in RAM 20, to the value associated with the index of the spoken City, and proceeds to Step 8.

However, as previously described, if the audio input is not consistent with an entry of the template or an error condition is encountered (for example, not a famous city), SRP 32 returns a negative result including a program-code appropriate error code, along with control, to the microcontroller, which increments the current failure count, retrieves the appropriate Error Message referenced by the NodeData instance being evaluated, such as “INVALID CITY” from memory, and updates display 18 with the Error Message.

If the current failure count does not exceed the retries allowed for this NodeData instance, microcontroller 14 returns to Step 5 to retry the current iteration of the Generic Algorithm. Because a city of interest may not be a famous city, the failureAction reference for this NodeData instance is beneficially set to the ROM address of another NodeData instance, and an appropriate choice for this NodeData instance may be to limit the retries allowed to one retry. Accordingly, when the current failure count exceeds the retries allowed, microcontroller sets the value of the NodeData pointer to the value of failureAction, thereby setting the value of the NodeData pointer to the ROM address of the next NodeData instance to be evaluated, and begins the next iteration of the Generic Algorithm by returning to Step 5.

In this example, the next NodeData instance to be evaluated, may be a secondary cities NodeData instance. In accordance with the generic data structure of FIG. 3, this NodeData instance references a secondary cities Prompt, and a secondary cities speech recognition template.

In this iteration of Step 5 of the Generic Algorithm, the microcontroller retrieves a secondary cities Prompt from memory, and updates display 18 to display “WHAT SECONDARY CITY?”. In this iteration of Step 6, Step 6 is as previously described, specifically with communication to SRP 32 of the ROM address of the secondary cities template.

In this iteration of Step 7 of the Generic Algorithm, Step 7 is as previously described, specifically with the audio input being compared for consistency with any entry of the randomly accessible secondary cities entries of the secondary cities template. If the audio input is consistent with an entry of the secondary cities template, then SRP 32 returns the index of the spoken City, and returns control, to microcontroller 14. The microcontroller then sets the current failure count stored in RAM to zero, and because the containsCities value is true for this iteration of Steps 5 to 7, sets the value of the selected City GMT Offset Data pointer stored in RAM 20, to the value associated with the index of the spoken City, and proceeds to Step 8.

However, as previously described, if the audio input is not consistent with an entry of the secondary cities template or an error condition is encountered (for example, invalid city), SRP 32 returns a negative result including a program-code appropriate error code, along with control, to the microcontroller, which increments the current failure count, retrieves the appropriate Error Message referenced by the NodeData instance being evaluated, such as “INVALID SECONDARY CITY” from ROM, and updates display 18 with the Error Message.

If the current failure count does not exceed the retries allowed for this NodeData instance, microcontroller 14 returns to Step 5 to retry the current iteration of the Generic Algorithm. Because the failureAction reference for this NodeData instance may be beneficially set to the ROM address of another NodeData instance, an appropriate choice for this NodeData instance may be to limit the retries allowed to one retry. Accordingly, when the current failure count exceeds the retries allowed, microcontroller sets the value of the NodeData pointer to the value of failureAction, thereby setting the value of the NodeData pointer to the ROM address of the next NodeData instance to be evaluated, and begins the next iteration of the Generic Algorithm.

In this example, the next NodeData instance to be evaluated, may be the previously described Region NodeData instance, followed by an appropriate previously described City By Region NodeData instance.

In any event, when the containsCities value is true, the microcontroller proceeds to Step 8 of the Generic Algorithm. Step 8 is as previously described, specifically with the microcontroller using the ROM address associated the spoken City, to retrieve the data associated with the spoken City from the GMT Offset Data Structure, selecting the GMT offset from the retrieved data, and as necessary, adjusting the GMT offset according to any date-based offset adjustment rules.

In this example, Steps 9 to 14 of the Generic Algorithm are as previously described, with display 18 being updated with current time information for the spoken City, including, if desired, current date information.

Algorithm with Functional Mode Selection

Referring again to FIGS. 1 and 2, an algorithm that includes Functional Mode Selection, and uses a Functional Modes speech recognition template that includes a set of function entries exemplified by “Set Time”, “Set Time Zone” and “Time Please”, may be beneficially used. To change the timekeeping device from normal clock function and begin execution of the Functional Mode Selection Function, microcontroller 14 advantageously receives an “Execute Functional Mode Selection Function” signal, for example, from a manual actuation event by use of actuating mechanism 34 by depression of a push button twice in rapid succession.

Actuating mechanism 34 may thus be used to signal “Execute Generic Worldwide Current Time Function” by depression of a push button once, and to signal “Execute Functional Mode Selection Function” by depression of a push button twice in rapid succession. As previously described, alternatively, speech recognition processor 32 may be maintained in a listening mode, and an audio event or command may be used to signal function change.

In Step 1, programmable microcontroller 14 (“PM”) powers up speech recognition processor 32. In Step 2, the microcontroller retrieves the “WHAT FUNCTION?” Prompt from memory (ROM 36 or Flash ROM 38), and updates display 18 to display the Prompt. In Step 3, the microcontroller commands SRP 32 to begin speaker independent speech recognition, and communicates to SRP 32 the ROM (ROM 36 or Flash ROM 38) address of the randomly accessible, Functional Modes speech recognition template, and begins waiting for the result of speaker independent speech recognition.

In Step 4, SRP 32 receives audio input from microphone 30 and compares the audio input for consistency with any entry of the randomly accessible function entries of the Functional Modes speech template. If the audio input is consistent with an entry of the template, then SRP 32 returns data representing the identity of that function entry, and returns control, to microcontroller 14. The microcontroller then sets the current failure count stored in RAM to zero.

If “SET TIME” is spoken in response to the Prompt, the microcontroller terminates execution of the Functional Mode Selection Function, and begins execution of a Set Time Function, by which local time may be set. Typical Prompts for a Set Time Function include “WHAT DAY?”, WHAT DATE?”, “WHAT HOUR?” “WHAT MINUTE?”, and “WHAT SECOND?”.

With reference generally to FIG. 4, if “TIME PLEASE” is spoken in response to the Prompt, the microcontroller terminates execution of the Functional Mode Selection Function, advantageously initializes iteration of the Generic Algorithm by setting the value of the node pointer to the ROM address of the root node, which in this case is beneficially the ROM address of the Time Please Mode node, and iterates the Generic Worldwide Current Time Function beginning at Step 5 thereof.

Advantageously, the Time Please Mode node includes an indexed set of ROM addresses of other nodes, and a Time Please Mode speech recognition template with a corresponding indexed set of entries such as “Famous Cities”, “Secondary Cities”, “City & Country”, “Region”, and “Major Country”. A convenient Prompt is “WHAT TIME PLEASE MODE?”. If a user responds to the Prompt with a choice such as “FAMOUS CITIES”, then the microcontroller sets the value of the node pointer to the ROM address of the Famous Cities node and the Generic Algorithm proceeds as previously described. A user may respond with any other speech template entry of the set, after which the microcontroller sets the value of the node pointer to the ROM address of the node corresponding to the entry spoken, and the Generic Algorithm proceeds as previously described until, if a user is successful, Steps 8 to 14 are carried out with display of time information for a city of interest.

A benefit of using Functional Mode Selection is that a user may, by speaking, choose a particular node and thereby obtain desired time information with a minimal number of prompts and audio input. Otherwise, a user may need to proceed through a significant number of prompts and audio responses to obtain desired time information.

For instance, if a timekeeping device in accordance with the invention, uses a hierarchical order that begins with a Famous Cities node, but the city of interest is not famous and has a name common to more than one country, the user will need to proceed through the hierarchical order of nodes before being able to use, for example, a Country node and then an appropriate City By Country node. By comparison, a timekeeping device that uses Functional Mode Selection, may allow a user to begin by selecting a hierarchical order that begins with a Country node. On the other hand, a hierarchical order that begins with a Famous Cities node is beneficial in other cases.

With continued reference to the Functional Mode Selection Function, if the audio input is not consistent with an entry of the Functional Modes template or an error condition is encountered, then SRP 32 returns a negative result including a program-code appropriate error code, along with control, to the microcontroller. The microcontroller increments the current failure count stored in RAM, retrieves the appropriate Error Message such as “INVALID FUNCTION” or “UNABLE TO RECOGNIZE”, from memory and updates display 18 with the Error Message, and waits for an appropriate predetermined period of seconds while displaying the Error Message.

However, if the current failure count exceeds a predetermined appropriate limit, microcontroller 14 sets the current failure count to zero, returns SRP 32 to a power down mode, terminates the Functional Mode Selection Function, and the timekeeping device returns to normal clock function.

However, if the current failure count does not exceed a predetermined appropriate limit, the microcontroller may retrieve a try again Message from memory, and update display 18 with the try again Message, and wait for an appropriate predetermined period of seconds while displaying the Message, and return to Step 4 of the Functional Mode Selection Function.

With detailed reference to FIG. 4, examples based upon Functional Mode Selection in which the root node is the Time Please Mode node, are provided. In the first example, Paris is the city of interest, and the desired time information is obtained by speaking “TIME PLEASE” (index entry 3 of Functional Modes template), “FAMOUS CITIES” (index entry 1 of Time Please Mode template) and then “PARIS” (index entry 2 of Famous Cities template) in response to appropriate Prompts. In the second example, Rheims is the city of interest, and the desired time information is obtained by speaking “TIME PLEASE” (index entry 3 of Functional Modes template), “REGION” (index entry 3 of Time Please Mode template), “WESTERN EUROPE” (index entry 1 of Region template) and then “RHEIMS” (index entry 4 of City By Region template) in response to appropriate Prompts.

If “SET TIME ZONE” is spoken in response to the Prompt, the microcontroller terminates execution of the Functional Mode Selection Function, and begins execution of a Set Time Zone Function beneficially by initializing iteration of the Generic Algorithm by setting the value of the node pointer to the ROM address of the root node, which in this case is the ROM address of the Time Please Mode node, and iterates the Generic Worldwide Current Time Function beginning at Step 5 thereof. Advantageously, a Time Zone Mode node may, similar to a Time Please Mode node, include an indexed set of ROM addresses of other nodes, and a Time Zone Mode speech recognition template with a corresponding indexed set of entries such as “Famous Cities”, “Secondary Cities”, “City & Country”, “Region”, and “Country”. A convenient Prompt is “WHAT TIME ZONE MODE?”. If a user responds to the Prompt with a choice such as “SECONDARY CITIES”, then the microcontroller sets the value of the node pointer to the ROM address of the Secondary Cities node and iterates the Generic Algorithm beginning at Step 5 thereof and proceeds as previously described through Step 8 thereof. The result of Step 8 is used to set the Local Time GMT Offset, and the local time subsequently displayed by the timekeeping device is based upon the newly determined Local Time GMT Offset.

An alternative Functional Modes speech recognition template may omit a “Time Please” entry, and include Time Please Mode speech recognition template entries, and iteration of a Generic Algorithm and selection of an entry may be initiated by speaking a phrase corresponding to the Time Please Mode template entries such as “FAMOUS CITIES” or “REGION”. In any event, an algorithm that uses Functional Mode Selection or the like, allows a user to obtain desired worldwide time information with minimal prompts and verbal responses, by beginning an inquiry by selection of a hierarchical order that is appropriate for a city of interest depending upon whether a city of interest is a famous city, or other considerations including that a particular city name is used in more than one country, or in more than one state or province or the like, of a country.

The present invention may be carried out with various modifications without departing from the spirit or essential attributes thereof. For example, actuating mechanism 42 may be used to signal “Execute Functional Mode Selection Function”, or to signal execution of an inventive Worldwide Current Time Function that includes a hierarchical order of speech recognition templates, or serve other useful purposes. Accordingly, reference should be made to the appended claims, rather than to the foregoing specification as indicating the scope of the invention.

1. A digital electronic timekeeping device capable of displaying current time information for a spoken worldwide location, and comprising
a microphone in input communication with a speech recognition processor for receiving audio input,
a programmable microcontroller in electronic communication with the speech recognition processor, and with a display for displaying information comprising time information and user interface information,
memory in electronic communication with the programmable microcontroller and the speech recognition processor, wherein program code for implementing an algorithm for operating the timekeeping device, the displayable user interface information, a GMT offset data structure, and a plurality of speech recognition templates are stored in the memory,
wherein the algorithm comprises a plurality of steps for a worldwide current time function, and wherein the plurality of speech recognition templates comprises a speech recognition template for a spoken worldwide location, wherein the speech recognition template for a spoken worldwide location comprises a plurality of randomly accessible city entries.

2. The timekeeping device of claim 1, wherein the algorithm further comprises steps for a functional mode selection function, and the plurality of speech recognition templates further comprises a functional modes speech recognition template comprising a plurality of function entries.

3. The timekeeping device of claim 1, wherein the algorithm for the worldwide current time function includes a hierarchical order of the speech recognition templates directed to the selection of a city spoken by the user.

4. The timekeeping device of claim 1, wherein the algorithm for the worldwide current time function iterates using a data tree directed to the selection of a city spoken by the user.

5. The timekeeping device of claim 1, further comprising an actuating mechanism for signaling the microcontroller to change the timekeeping device from normal clock function, wherein the actuating mechanism also signals the microcontroller to execute the worldwide current time function.

6. The timekeeping device of claim 2, further comprising an actuating mechanism for signaling the microcontroller to change the timekeeping device from normal clock function, wherein the actuating mechanism also signals the microcontroller to execute the functional mode selection function.

7. The timekeeping device of claim 6, wherein audio input consistent with a function entry of the functional modes speech recognition template, initializes execution of the worldwide current time function.

8. The timekeeping device of claim 1, wherein the plurality of speech recognition templates further comprises a trigger phrase speech recognition template, wherein when the timekeeping device is in the worldwide current time function, a spoken trigger phrase consistent with the trigger phrase speech recognition template, initiates the display to display a worldwide location prompt selected from the user interface information.

9. The timekeeping device of claim 1, wherein the speech recognition template for a spoken worldwide location is selected from a famous cities template, a secondary cities template, a city and country template, city by region template, a city by country template, a city by state template, and a city by province template.

10. The timekeeping device of claim 1, wherein the displayable information further comprises location information.

11. The timekeeping device of claim 1, wherein the displayable time information comprises date information.

12. The timekeeping device of claim 1, wherein the displayable user interface information comprises prompts and messages.

13. The timekeeping device of claim 1, wherein the memory comprises flash memory, and the timekeeping device further comprises an external interface in electronic communication with the programmable microcontroller and the memory, for receiving digital information from an external information source, wherein the programmable microcontroller updates the flash memory with the digital information received from the external information source.

14. The timekeeping device of claim 13, wherein the algorithm for the worldwide current time function iterates using a data tree directed to the selection of a city spoken by the user, and wherein the digital information received and stored in memory, comprises data of the data tree.

15. The timekeeping device of claim 13, wherein the external interface is selected from a wireless interface and a physical interface, and the timekeeping device is a watch.

16. The timekeeping device of claim 1, further comprising a real time clock in electronic communication with said programmable microcontroller.

17. The timekeeping device of claim 1, wherein the speech recognition processor is a speaker independent speech recognition processor.

18. The timekeeping device of claim 12, wherein the prompts are selected from “WHAT FUNCTION?”, “WHAT TIME PLEASE MODE?”, “WHAT FAMOUS CITY?”, “WHAT SECONDARY CITY?”, “WHAT CITY & COUNTRY?”, “WHAT REGION?”, “WHAT COUNTRY?”, “WHAT MAJOR COUNTRY?” “WHAT STATE?”, “WHAT PROVINCE?”, and “WHAT CITY?”.
